(19) United States
(12) Patent Application Publication
(10) Pub. No.: US 2004/0239983 A1
(43) Pub. Date: Dec. 2, 2004

(54) Apparatus, method, and program for recording images

(75) Inventor: Kazuo Shiota, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/804,213

(22) Filed: Mar. 19, 2004

(30) Foreign Application Priority Data
Mar. 20, 2003 (JP) 078229/2003
Jan. 21, 2004 (JP) 013111/2004

(51) Int. Cl. G06K 15/00; G06F 15/00; G06K 9/00

(52) U.S. Cl. 358/1.15; 382/224; 382/165; 358/1.18; 358/1.16

(57) ABSTRACT

Images recorded on a film can be easily classified and selected for being recorded in a recording medium M. A scanner reads the images from a developed negative film and obtains image data sets. The image data sets are stored in an image storage server. When a user inputs an instruction to display the image data sets from a terminal, an image organizing server classifies the image data sets and carries out selection therefrom. A result thereof is displayed on the terminal. After the result is corrected if necessary, a media drive records the image data sets that have been classified and selected in the recording medium in response to a recording instruction input from the user.

### BACKGROUND OF THE INVENTION

1. Field of the Invention

The present invention relates to an apparatus and a method for recording image data sets obtained by a digital camera or by reading images recorded on a roll of film in a portable recording medium such as a CD-R and a DVD-R. The present invention also relates to a program that causes a computer to execute the image recording method.

2. Description of the Related Art

There has been proposed a photograph service system regarding image data sets obtained by a digital camera or by reading images recorded on a negative film with a reading device such as a scanner. such image data sets are printed or recorded in a portable recording medium such as a CD-R and a DVD-R (see U.S. Patent Laid-open No. 20010019430). In such a photograph service system, a DPE store that provides a photograph service reads all images from a negative film whose development and printing was requested by a user, and image data sets obtained in this manner are recorded in a recording medium. Alternatively, the DPE store reads all image data sets obtained by a digital camera from a memory card, and records the image data sets in a recording medium. Therefore, the recording medium wherein the image data sets are recorded can be provided to the user for a comparatively low service charge. Furthermore, by authoring the image data sets, the image data sets can be recorded in a recording medium in a video CD format or a DVD video format that enables reproduction of the image data sets as a slide show, for example. In this manner, the user can enjoy the slide show using the images he/she photographed, by simply setting the recording medium received from the DPE store in a reproduction apparatus such as a personal computer or a DVD player.

However, in the photograph service system described above, all the images recorded on the roll of film or all the image data sets recorded in the memory card are stored in the recording medium. Therefore, even if some of the images are personal, blurry, or represent the user closing his/her eyes, the images are also shown especially in the case of the slide show with his/her friends although the user does not wish to show the images to the friends. For this reason, the negative film that has been developed may be provided to the user in advance so that the user can make selection from the film. Only the selected images are then read and recorded in a recording medium. Alternatively, only images selected by the user in advance may be recorded in the memory card to be provided to the DPE store. However, image selection is a troublesome operation for the user, and selective image reading from the film is also a time-consuming operation for the DPE store. Consequently, productivity of the operation for recording image data sets in a recording medium becomes low, which leads to a higher charge of the service for image data recording in a recording medium.

### SUMMARY OF THE INVENTION

The present invention has been conceived based on consideration of the above circumstances. An object of the present invention is therefore to record image data sets in a recording medium by easily carrying out classification and selection thereon.

An image recording apparatus of the present invention comprises:

image acquisition means for obtaining image data sets;

classification selection means for carrying out classification and/or selection on the image data sets; and

media recording means for recording the image data sets that have been subjected to the classification and/or the selection in a portable recording medium.

The image data sets can be obtained by reading images recorded on a roll of film or by reading prints. Alternatively, a memory card storing image data sets obtained by a digital camera may be read to obtain the image data sets. Hereinafter, a roll of film, prints, a memory card, or the like from which the image data sets are obtained is called a “source”. The image data sets may be obtained from a single source such as a memory card alone, or from a plurality of sources such as a memory card and a roll of film, or a plurality of rolls of film.

A roll of film refers to a negative film or a reversal film that has been developed, or a developed APS film having a magnetic component such as a magnetic strip or layer that enables magnetic information storage, for example.

The portable recording medium used by the image recording apparatus refers to a recording medium corresponding to various recording methods (such as a method using semiconductors, magnetic recording, and optical recording), as long as the recording medium can record the image data sets therein and can be carried, For example, the portable recording medium can be a CD-R, a DVD-R, a DVD-RAM, an FD, an MO disc, or a memory card.

The classification on the image data sets refers to grouping the image data sets according to a classification condition that has been predetermined. More specifically, the image data sets can be classified according to the classification condition such as date of photography, photography location, and characteristic of scenes represented by the image data sets.

In the case where the image data sets are classified according to date of photography, information on the date of photography is necessary. If the image data sets are obtained by reading images recorded on a roll of APS film that has a magnetic component for recording magnetic information, the information on the date of photography is recorded in the magnetic component and can be used for the classification. For an ordinary 135-film or prints, the date of photography is recorded at the time of photography. Therefore, by carrying out character recognition on the date of photography recorded in the images or the prints, the information can be obtained. In the case of image data sets obtained by a digital camera, tag information includes the information on the date, of photography, which can be used for the classification of the image data sets.

As a method of the image classification according to scene characteristic, colors of the images, density distribution therein, or a shape of a subject therein are analyzed. Thereafter, the images whose scene characteristic is similar can be grouped together.

The image data sets may be classified in a stepwise manner according to a plurality of conditions, For example, if the date of photography and the scene characteristic are used as the conditions, the image data sets are classified first according to the date of photography. Thereafter, the image data sets classified according to the date of photography are further classified according to the scene characteristic.

The selection on the image data sets refers to selection of a preferred portion of the image data sets. More specifically, a portion of the image data sets representing no blur and a person or persons whose eyes are not closed may be selected, for example.

If the classification is carried out in addition to the selection, the image data sets maybe subjected to the selection first and then subjected to the classification, or vise versa.

The image recording apparatus of the present invention may further comprise reception means for receiving an instruction to carry out further classification and/or further selection on the image data sets that have been subjected. to the classification and/or the selection and for carrying out the further classification and/or the further selection. In this case, the media recording means may record in the recording medium the image data sets that have been subjected to the further classification and/or the further selection by the reception means.

The reception means can be any means that enables reception of an instruction to carry out the further classification and/or the further selection from the user who requested recording of the image data sets in the recording medium with use of an apparatus accessible to the image data sets that have been classified and/or selected. More specifically, the reception means may be a Web server that receives the further classification and/or selection instruction from the user using a personal computer or a mobile terminal such as a cellular phone or a PDA. The user can also input the further classification and/or selection instruction on the image data sets by using a reception machine installed in a DPE store that manages an image storage server. In this case, the image storage server can be used as the reception means, since the image storage server is directly connected to the reception machine.

In the image recording apparatus of the present invention, the media recording means may record the image data sets that have been subjected to the classification and/or the selection in the recording medium in a format that enables display of a slide show.

The format that enables display of a slide show refers to a format that enables serial reproduction of the image data sets in the recording medium by setting the recording medium in a personal computer, a DVD player, or the like. For example, the format refers to a video CD format or a DVD video format, depending on the recording medium wherein the image data sets are stored.

In the image recording apparatus of the present invention, the media recording means may record in the recording medium the image data sets having been subjected to the classification and/or the selection in a manner that enables printing thereof.

Recording the image data sets in a manner that enables printing thereof refers to recording the image data sets in the recording medium at a high resolution that enables printing of the images in high quality.

An image recording method of the present invention comprises the steps of:

obtaining image data sets;

carrying out classification and/or selection on the image data sets; and

recording the image data sets that have been subjected to the classification and/or the selection in a portable recording medium.

The image recording method of the present invention may be provided as a program that causes a computer to execute the method.

According to the present invention, the image data sets are recorded in the recording medium after being subjected to the classification and/or the selection, without troubling the user or the DPE store. Furthermore, the user does not show all the images if only the image data sets that have been classified and/or selected are reproduced.

By receiving the instruction to carry out the further classification and/or the further selection on the image data sets that have been classified and/or selected, the image data sets can be classified and/or selected as the user wishes. In this manner, the image data sets can be recorded in the recording medium while reflecting an intension of the user.

Furthermore, by recording the image data sets in the recording medium in the format that enables display of a slide show, the user can enjoy the slide show by simply inserting the recording medium in a reproduction apparatus such as a personal computer or a DVD player.

In addition, by recording the image data sets that have been classified and/or selected in the recording medium in the manner that enables printing thereof, the user can print the image data sets for appreciation thereof.

### BRIEF DESCRIPTION OF THE DRAWINGS

FIG. 1 is a block diagram showing a configuration of a photograph service system adopting an image recording apparatus of a first embodiment of the present invention;

FIG. 2 shows how image data sets are classified according to date of photography;

FIG. 3 shows an image having the date of photography recorded in a predetermined area;

FIGS. 4A to 4C are diagrams showing results of classification and selection displayed on a terminal of a user;

FIG. 5 is a diagram showing a structure of files in a recording medium;

FIG. 6 is a flow chart showing a procedure carried out in the first embodiment;

FIG. 7 is a diagram explaining how image data sets obtained from a plurality of sources are classified and selected;

FIG. 8 is a database having file names of the image data sets classified in folders;

FIG. 9 is a block diagram showing a configuration of a photograph service system adopting an image recording apparatus of a second embodiment or the present invention; and

FIG. 10 is a diagram showing a result of classification and selection of image data sets displayed on a reception machine in a store in the second embodiment.

### DESCRIPTION OF THE PREFERRED EMBODIMENTS

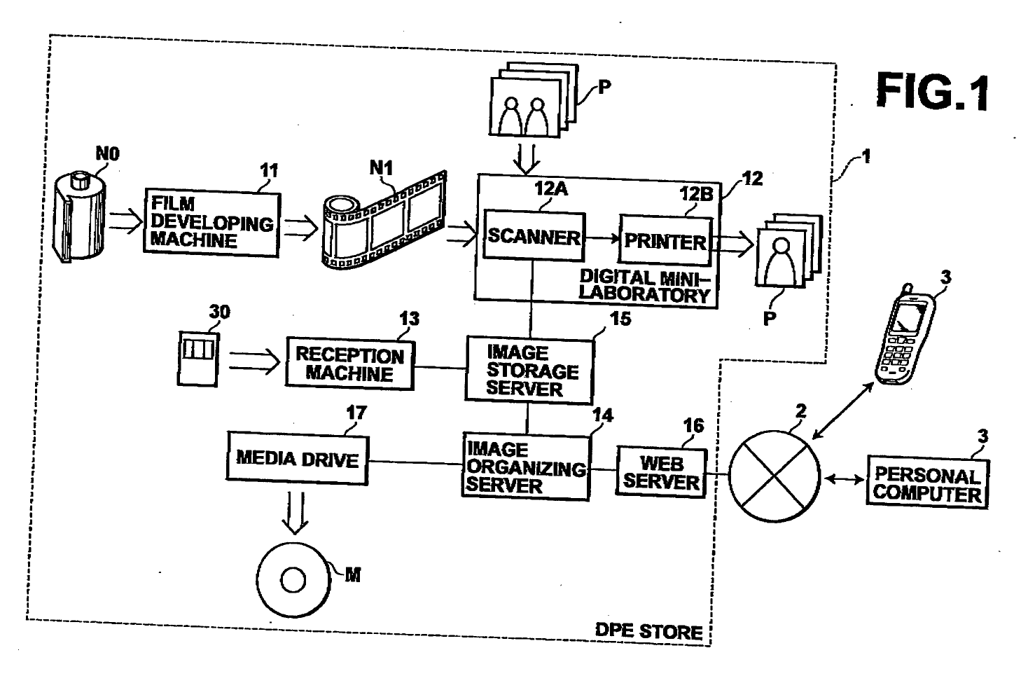

Hereinafter, embodiments of the present invention will be explained with reference to the accompanying drawings. FIG. 1 is a block diagram showing a configuration of a photograph service system adopting an image recording apparatus of a first embodiment of the present invention. As shown in FIG. 1, the photograph service system in the first embodiment is provided by a DPE store 1. The photograph service system comprises a film developing machine 11 for developing a negative film N0 whose development and printing is requested by a user from the DPE store 1, a digital mini-laboratory 12 for obtaining image data sets Si (i=1˜n) by reading images recorded on a developed negative film N1 or prints P, a reception machine 13 installed in the DPE store 1 for reading the image data sets Si from a memory card 30 used for photography by a digital camera, an image organizing server 14 for classifying the image data sets Si and selecting which of the image data sets Si are to be recorded in a recording medium M such as a CD-R or a DVD-R, an image storage server 15 for storing the image data sets Si for each user and for each order, a Web server 16 connected to the Internet 2, and a media drive 17 for recording the image data sets Si that have been classified and selected by the image organizing server 25 14 in the recording medium M.

The image organizing server 14 corresponds to classification selection means while the media drive 17 acts as media recording means. The Web server 16 and the image storage server 15 correspond to reception means while the reception machine 13 acts as image acquisition means.

The digital mini-laboratory 12 comprises a scanner 12A (corresponding to image acquisition means) for obtaining the image data sets Si by reading the images recorded on the developed negative film N1 or the prints P, and a printer 12B for obtaining prints by printing the image data sets Si. The digital mini-laboratory 12 issues an order ID and a user ID when an order is placed for recording in the recording medium M the image data sets that are obtained from the prints P or from the film N0 to be developed and printed, or obtained by a digital camera. The digital mini-laboratory 12 prints the order ID and the user ID on paper by using the printer 12B, and the paper is provided to the user who placed the order. The user is also provided with a user ID card that magnetically stores the user ID. The user accesses the Web server 16 of the DPE store 1 via the Internet 2 by using the terminal 3 such as a personal computer, a cellular phone, or a PDA of his/her own, and inputs the user ID and the order ID from the terminal 3 to the Web server 16. In this manner, the user can view the image data sets Si with use of the terminal 3. In response to the input of the user ID and the order ID by the user from the terminal 3 to the Web server 16, the image storage server 15 reads the image data sets Si corresponding to the user ID and the order ID, and inputs the image data sets Si to the image organizing server 14.

As has been described above, the image organizing server 14 carries out the classification and the selection on the image data sets Si. The classification will be explained first.

The image organizing server 14 classifies the image data sets Si according to date of photography thereof. For example, if the negative film N0 whose development and printing was requested by the user has 24 images, 24 image data sets S1˜B24 are obtained. As shown in FIG. 2, if the date of photography thereof ranges from Feb. 11 to 13 of 2003, the image data sets S1˜S24 are classified into 3 groups according to the date of photography.

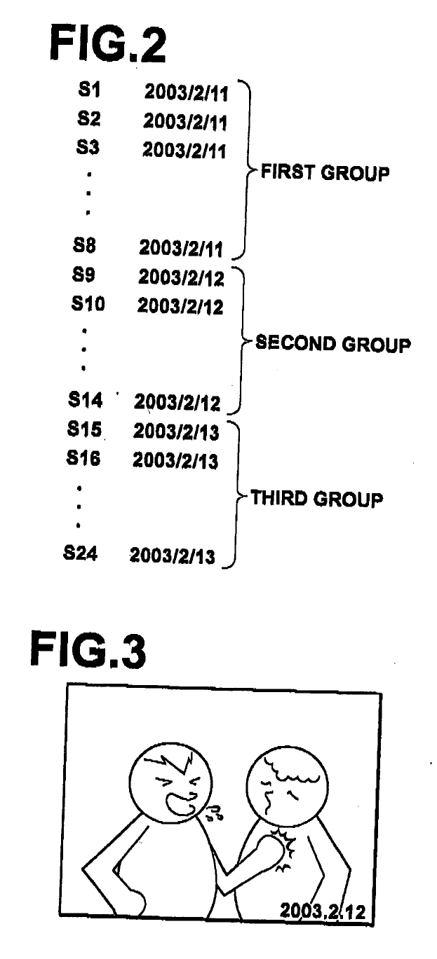

The images recorded on the negative film N1 includes the date of photography recorded in a predetermined area in the lower right corner thereof, as shown in FIG. 3. Therefore, by carrying out character recognition on the predetermined area in the images represented by the image data sets S1˜S24, information on the date of photography can be obtained. In the case where the negative film N1 is a so-called APS film having a magnetic component such as a magnetic strip or layer that can record magnetic information, the information on the date of photography is recorded in the magnetic component and read magnetically for the classification.

The prints P also have the date of photography recorded in a predetermined area in the lower right corner thereof, as in the case of the images recorded on the negative film N1. Therefore, the information on the date of photography can also be obtained by carrying out character recognition on the predetermined area. In the case where the image data sets Si have been obtained by a digital camera, the information on the date of photography is included in tag information. Therefore, the information can be used as it is for the classification.

The image data sets Si may be classified into groups of similar scenes by analyzing scene characteristics such as colors, density distribution, and a shape of a subject, for example. The image data sets Si may also be classified according to human subject in the images by carrying out subject recognition on the images.

There has been proposed a digital camera having a GPS function and enabling recording of the latitude and the longitude of a photography location as photography location information in tag information of an image data set. Therefore, the image data sets Si obtained by such a digital camera may be classified according to the photography location, with reference to the photography location information.

The image organizing server 14 selects the image data sets to be recorded in the recording medium M from the image data sets that have been classified, according to predetermined selection conditions. More specifically, in the case where the images represented by the image data sets Si are images of scenery, the selection conditions refer to a degree of underexposure/overexposure (including appropriate exposure), a degree of blur (including no blur), and a degree of camera shake (including no shake). Depending on the number of the image data sets Si in each of the groups, a level of selection (that is, the degrees of underexposure/overexposure, blur, and camera shake) is set higher if the number is larger. In the case of human images, the selection conditions include presence of blur around a face and a degree thereof, and presence of closed eyes, in addition to the selection conditions for scenery. Since how a face looks is most important in the case of human images, the degree of blur around a face and presence of closed eyes may be used solely as the selection conditions.

In the case where the number of the image data sets is one for one of the groups, the image data set is selected. Otherwise, it is judged first whether each of the image data sets in the group represents scenery or a human image. In the case of scenery, the degrees of underexposure/overexposure, blur, and camera shake are judged by analyzing the respective image data sets in the group. The image data sets are then subjected to the selection according to the selection conditions set in accordance with the number of the image data sets in the group. In the case of human images, the image data sets are selected according to the degree of blur around a face and presence of closed eyes, in addition to the selection conditions for scenery. Methods of finding the degrees of underexposure/overexposure, blur, and camera shake, and methods of face extraction and closed-eye detection are not limited to specific methods, and any known methods can be used. For example, in order to find the degree of blur, a method described in Japanese Patent Publication No. 3 (1991)-76449 can be used. More specifically, contrasts of an entire image and local areas therein are found. A quantity determined by frequency distribution of the local contrasts is used as a first characteristic quantity while the contrast of the entire image is used as a second characteristic quantity. In a characteristic space determined by the first and second characteristic quantities, areas of blurry images and clear images are empirically found, and a boundary separating the two areas is determined in advance. When the degree of blur is actually found for each of the images represented by the image data sets, the first and second characteristics thereof are found and plot in the characteristic space. By judging the position of the coordinates of the characteristic quantities in the space relative to the boundary, the corresponding image can be judged to be blurry or not blurry. In the case of a blurry image, the degree can be found according to how far the coordinates are from the boundary. Instead of the entire image, a portion of the image representing a main subject (such as the center thereof in many cases) may be used for judgment of blur.

In the case of human images, a face area is extracted. By applying the method described above to the face area, whether the face area is blurry or not can be detected. For a blurry face, the degree of blur can also be detected. For face area extraction, a method described in Japanese Unexamined Patent Publication No. 2000-48184 may be used, for example. More specifically, pre-processing such as pixel thinning and brightness adjustment is carried out on each of the human images for face area extraction. Pixels of skin color are then extracted from the pre-processed image. Distribution of projection of the skin-color pixels is then found, and a skin-color area that is characteristic to a face is detected according to a shape of the distribution. In this manner, a face area candidate is found, and the face area candidate is judged to be an area of face or non-face object according to a predetermined method using a neural network, for example.

For detecting closed eyes, a method of extracting eye areas for detecting red eyes can be used. For example, an area including eyes (specified either manually or automatically) is cut from the corresponding image, and a brightness histogram is generated for the area. A low brightness area is extracted from the histogram, and areas of eyes are extracted by trimming the low brightness area. Presence of closed eyes can be judged based on a size (including 0) of the eye areas.

The image storage server 15 stores the image data sets Si obtained by the digital mini-laboratory 12 according to the user ID and the order ID. The image storage server 15 reads the image data sets Si upon necessity, and sends the image data sets Si to the reception machine 13 or the Web server 16.

The Web server 16 is connected to the Internet 2 and accessible from the terminal 3. when the user inputs the user ID and the order ID from the terminal 3, the Web server 16 reads the image data sets Si corresponding to the user ID and the order ID from the image storage server 15, and generates a list of thumbnail images. The Web server 16 sends the list and the image data sets selected from the thumbnail images to the terminal 3.

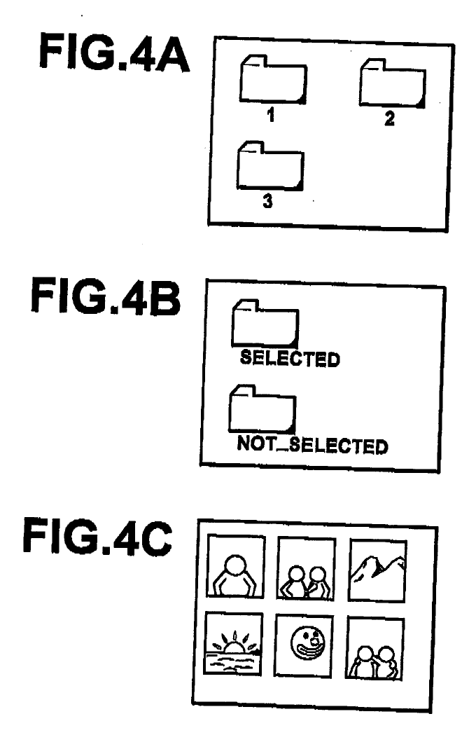

The Web server 16 displays a result of the classification and the selection carried out by the image organizing server 14 on the terminal 3. FIGS. 4(a) to 4(c) show the result displayed on the terminal 3. As shown in FIG. 4A, folders (added with names such as 1, 2, and 3) for the image data sets that have been classified are displayed first on the terminal 3. By opening any one of the folders, folders for the image data sets therein that are selected and not selected are displayed, as shown in FIG. 4B. The folders have names such as “Selected” and “Not_Selected”.

When the user opens either one of the folders, a list of the thumbnail images of the image data sets therein Is displayed, as shown in FIG. 4C. The user can open any one of the folders for correcting the result of the classification and the selection. More specifically, the user can correct the result by dragging and dropping the thumbnail image or images as he/she wishes.

The user can also display the result of the classification and the selection on the reception machine 13 by accessing the image storage server 15 from the reception machine 13 through an input of the user ID and the order.ID. In this case, the same screen as on the terminal 3 is displayed on a monitor (not shown) of the reception machine 13, whereby the user can confirm the result of the classification and the selection. The user can also correct the result as he/she wishes. The reception machine 13 may be equipped with a user ID card reader. Being read from the user ID card, the user ID is input to the reception machine 13.

When the user instructs the Web server 16 to record the image data sets in the recording medium M from the terminal 3 after correcting the result of the classification and the selection, the media drive 17 records the image data sets that have been classified and selected in the recording medium M. More specifically, a folder is generated for each of the groups in the recording medium M and the image data sets that have been selected are stored therein.

The media drive 17 converts and records the image data sets in the folders according to a video CD format or a DVD video format (depending on the type of the recording medium M) that enables reproduction of a slide show. The media drive 17 also records the image data sets at a high resolution in the recording medium M for enabling the user to print the image data sets with his/her printer.

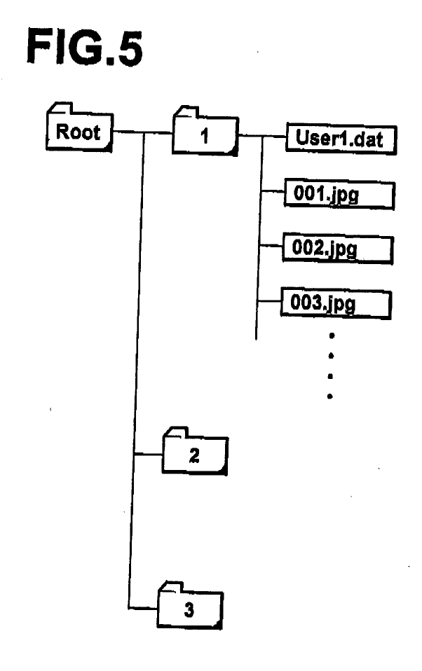

Therefore, in a file structure of the image data sets in the recording medium M shown in FIG. 5, each of the folders has a file having information on the content of the slide show (a file named “user1.dat”) therein and the high-resolution image data sets (such as 001.jpg, 002.jpg in FIG. 5) classified into the folder. In the case where the image data sets enabling the slide show in the video CD format or the DVD to video format are recorded in the recording medium M, the file having the information on the content of the slide show enabling reproduction of only the image data sets that have been selected is recorded in the recording medium M according to the format. The image data sets are given the file names in order of photography. If the date of photography is the same, the order of image reading from the negative film N1 is used for the file names.

The user may choose whether or not the conversion for enabling slide-show display is carried out. In this case, the user is asked about whether or not the conversion into the slide-show reproduction format is carried out when the images are displayed on the terminal 3 or the reception machine 13.

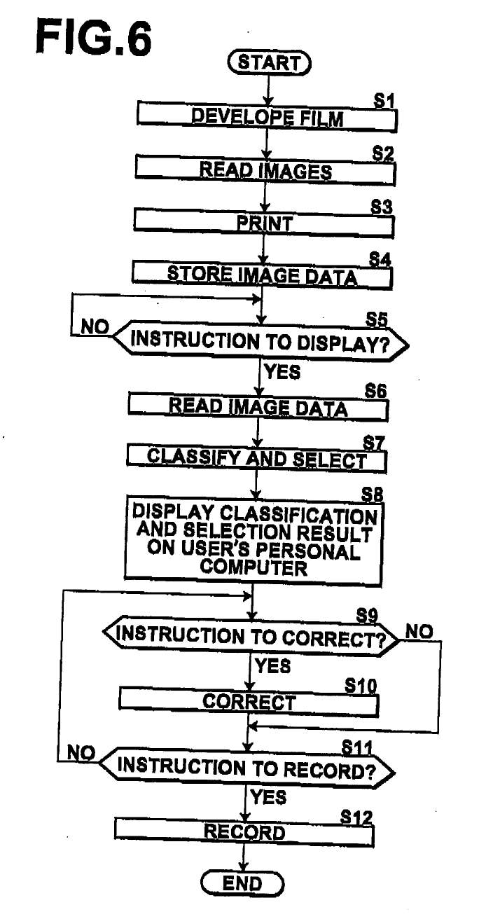

In some cases, the same image data set is classified into a plurality of groups. In this case, the same image data set may be stored in each of the corresponding folders. However, only one of the folders may have the image data set and the other folder or folders have only link information thereto. In this manner, a free space in the recording medium M can be saved without storing the same image data set in all the corresponding folders. A procedure carried out in the first embodiment will be explained next. FIG. 6 is a flow chart showing the procedure. The user has requested development and printing of the negative film N0 from the DPE store 1, and the images are displayed on the terminal 3 of the user when the user accesses the Web server 16 from the terminal 3. The film developing machine 11 of the DPE store 1 develops the negative film N0, and obtains the negative film N1 that has been developed (Step S1). The scanner 12A of the digital mini-laboratory 12 reads the images recorded thereon, and obtains the image data sets Si representing the images (Step S2). The image data sets Si are input to the printer 12B where the prints are generated by printing the image data sets Si (Step S3).

The image data sets Si are sent to the image storage server 15 in relation to the user ID and the order ID, and the image storage server 15 stores the image data sets Si (Step S4). The Web server 16 then starts monitoring whether or not the user has input an instruction to display the image data sets Si from the terminal 3 (Step S5). If a result at Step S5 is affirmative, the image organizing server 14 reads the image data sets Si corresponding to the user ID and the order ID (Step S6), and carries out the classification and the selection (Step S7).

The Web server 16 displays the result of the classification and the selection on the terminal 3 (Step S8). The user corrects the result of the classification and the 5 selection if necessary, while viewing the result displayed on the terminal 3. The Web server 16 judges whether or not.the user has input an instruction to correct the result (Step S9), and corrects the result (Step S10) if a result at Step S9 is affirmative. The Web server 16 starts monitoring whether or not the user has input an instruction to record the image data sets in the recording medium M (Step S11). If a result at Step S11 is affirmative, the image data sets Si that have been classified and selected are recorded in the recording medium M (Step S12) to end the procedure. If the result at Step S9 is negative, the procedure goes to Step S11. If the result at Step S11 is negative, the procedure returns to Step S9. The recording medium M storing the image data sets Si is provided to the user.

As has been described above, according to the first embodiment, the image data sets Si obtained by image reading from the negative film N1 are classified and selected, and then recorded in the recording medium M. Therefore, the image data sets Si having been classified and selected can be recorded in the recording medium N without causing a trouble on the DPE store 1 or the user. Furthermore, by reproducing the image data sets only in one of the groups, the user does not need to show all the image data sets to others.

By enabling the user to further classify and select the image data sets that have been classified and selected, the image data sets can be classified and selected as the user wishes. Therefore, the image data sets can be recorded in the recording medium M while reflecting an intension of the user.

By recording in the recording medium M the image data sets that have been classified and selected for display of the slide show, the user can enjoy the slide show by simply setting the recording medium M in a reproduction apparatus such as the terminal 3 or a DVD player.

Moreover, by recording the image data sets that have been classified and selected in the recording medium M for printing at high resolution, the user can appreciate the images represented by the image data sets in the recording medium M by printing thereof.

In the first embodiment described above, the images are read from the negative film N1 and classified and selected. In the case where the user requests development and printing of a plurality of negative films N0, image data sets are obtained by reading images from each of negative films N1 that have been developed. Thereafter, all the image data sets obtained from all the negative films N1 may collectively be subjected to the classification and the selection. In this case, some of the image data sets obtained from some of the negative films N1 may be classified into the same group.

In the above embodiment, the image data sets Si may be obtained from not only one source but also a plurality of sources (such as the negative film N1, the prints P, and the memory card 30) to be classified and selected in the same manner. In this case, the user notifies the DPE store 1 of his/her intension to collectively deal with all the image data sets from all the sources in one order when the user requests development and printing, recording of the image data sets read from the prints P in the recording medium M, and recording of the image data sets read from the memory card 30 in the recording medium M, for example. In this manner, the same order ID is issued for the order requesting the development and printing, the recording of the image data sets read from the prints P in the recording medium M, and the recording of the image data sets read from the memory card 30 in the recording medium M. Hereinafter, how image data sets Si obtained from a plurality of sources are classified and selected will be explained next.

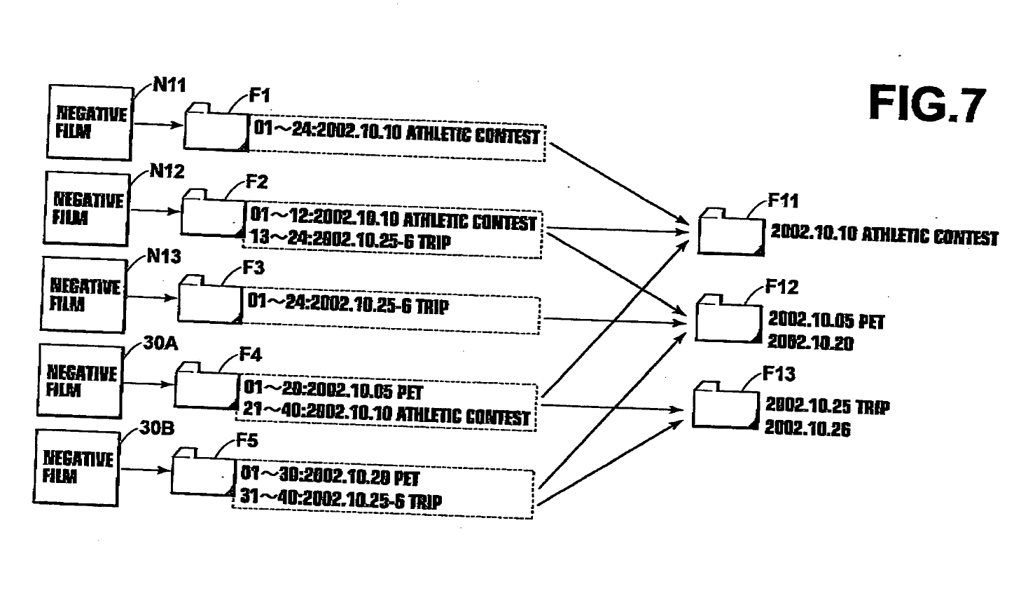

FIG. 7 is a diagram explaining classification and selection of image data sets Si obtained from a plurality of sources comprising 3 negative films (denoted by N11˜N13) and 2 memory cards (referred to as 30A and 30B). As shown in FIG. 7, the negative film N11 has 24 images (01˜24) of an athletic contest on Oct. 10, 2002. Image data sets obtained from the negative film N11 are stored in a folder F1 in the image storage server 15.

The negative film N12 has 12 images (01˜12) of the athletic contest and 12 images (13˜24) of a trip on Oct. 25 and 26, 2002. Image data sets obtained from the negative film N12 are stored in a folder F2 in the image storage server 15.

The negative film N13 has 24 images (01˜24) of the trip, and image data sets obtained from the negative film N13 are stored in a folder F3 in the image storage server 15.

The memory card 30A has 20 images (01˜20) of a pet photographed on Oct. 5, 2002. The memory card 30A also has 20 images (21˜40) of the athletic contest on Oct. 10, 2002. Image data sets obtained from the memory card 30A are stored in a folder F4 in the image storage server 15.

The memory card 30B has 30 images (01˜30) of the pet photographed on Oct. 20, 2000. The memory card 30B also has 10 images (31˜40) of the trip on Oct. 25 and 26, 2002. Image data sets obtained from the memory card 30B are stored in a folder F5 in the image storage server 15.

The image organizing server 14 carries out the classification and the selection on the image data sets stored in the folders F1 to F5. The selection is carried out in the same manner as in the first embodiment described above. Therefore, only the classification will be explained here. The image organizing server 14 firstly classifies the image data sets Si stored in the folders F1 to F5 according to date of photography thereof. Consequently, the image data sets Si are classified into the following 5 groups;

Oct. 5, 2002 (pet)

Oct. 10, 2002 (athletic contest)

Oct. 20, 2002 (pet)

Oct. 25, 2002 (trip)

Oct. 26, 2002 (trip).

The image organizing server 14 further analyzes scenes represented by the image data sets Si classified according to the date of photography, and groups the image data sets of the scenes having similar characteristics. In this manner, the groups of October 5 and 20 are classified into one group. The groups of October 25 and 26 are also grouped together.

In this manner, the image data sets Si stored in the folders F1 to F5 are copied into a folder F11 storing the image data sets obtained on October 10, a folder F12 storing the image data sets representing the pet photographed on October 5 and 20, and a folder F13 storing the image data sets of the trip on October 25 and 26.

Therefore, by accessing the Web server 16 from the terminal 3, the user can view the images classified into the 3 folders F11 to F13. The image data sets in each of the folders are sorted according to the date (or date and time) of photography. Since only the date of photography is known for the images obtained from the negative films N11 to N13, the corresponding image data sets are sorted in order of image reading from the films N11 to N13.

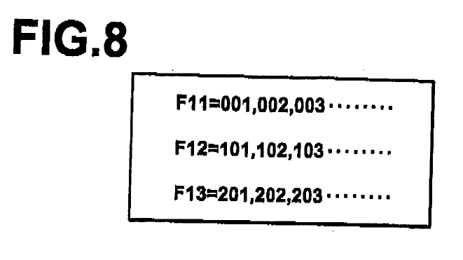

In this example, the image data sets stored in the folders F1 to F5 are copied into the folders F11 to F13. However, in order to save storage space in the image storage server 15, only link information to the image data sets Si is preferably stored in each of the folders F11 to F13. Alternatively, as shown in FIG. 8, a database storing file names (such as 001, 002, 101, 102, 201, and 202) of the image data sets classified in each of the folders F11 to F13 may be generated so that the image data sets Si can be viewed with reference to the database instead of actually storing the image data sets or the link information in the folders F11 to F13.

In the first embodiment described above, the user may receive some images from his/her friend and wish to include the images in the groups after the image data sets have already been recorded in the recording medium M. In this case, the user can add new image data sets representing the images he/she received to the image data sets stored in the recording medium M. Hereinafter, this case will be explained as a second embodiment of the present invention.

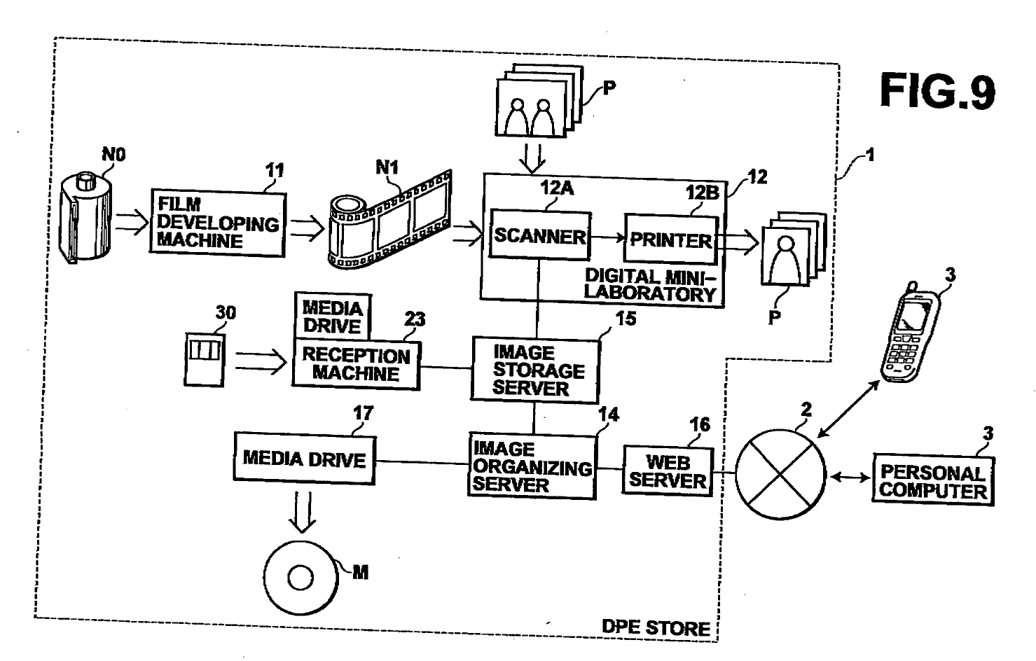

FIG. 9 is a block diagram showing a configuration of a photograph service system adopting an image recording apparatus of the second embodiment. In the second embodiment, the same elements as in the first embodiment have the same reference numbers, and detailed explanations thereof will be omitted. In the second embodiment, a reception machine 23 is installed in the DPE store 1 and equipped with a media drive that can read and write information from and in the recording medium M.

The user has placed an order (hereinafter referred to as the latest order) for film development and printing, recording image data sets read from prints P in the recording medium M, and/or recording image data sets obtained by a digital camera in the recording medium M. The image storage server 15 already stores the image data sets classified and selected in the latest order and in the past order.

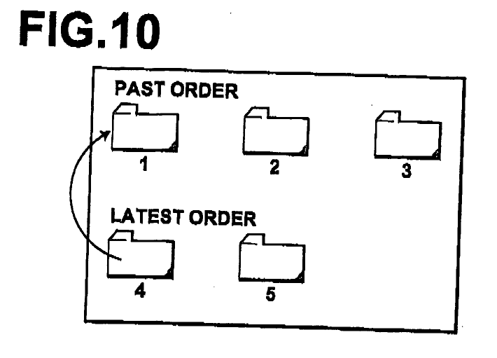

The user causes the reception machine 23 to read the user ID from the user ID card. In this manner, the user ID is input to the reception machine 23. The user also inputs the order IDs of the latest order and the past order for display of the image data sets stored in the image storage server 15 on the reception machine 23. In this manner, on the reception machine 23 are displayed the folders 1,2, and 3 classified in the past order and folders 4 and 5 classified in the latest order, as shown in FIG. 10. The user selects any one of the folders as he/she wishes, and displays the list of the thumbnail images of the image data sets classified in the selected folder, as in the first embodiment.

After the user confirms the content of the image data sets classified and selected into the folder, the user can drag and drop any one of the folders (such as the folder 4) in the latest order or a thumbnail image or thumbnail images therein to one of the folders (such as folder 1) in the past order. In this manner, the user can include any one of the image data sets in the latest order in any one of the groups of the image data sets in the past order.

In some cases, the image storage server 15 may not store the image data sets in the past order anymore due to expiration of storage period thereof. In this case, the user inserts the recording medium M in the reception machine 23, and causes .the reception machine 23 to read the image data sets that have been classified and selected in the recording medium M. In this manner, the user can temporarily store the image data sets in the past order again in the image storage server 15.

When the user instructs the reception machine 23 to write the image data sets after the classification and the selection thereof, the machine 23 adds the image data sets to the image data sets in the past order that have been classified and selected in the recording medium M.

In this case, the image data sets may be added in the video CD format or the DVD video format, as in the case of the first embodiment. A play list file is newly generated for defining reproduction order of the image data sets, and the play list file already existing in the recording medium M is set inactive. The reproduction order in the play list may represent order of photography of the image data sets if the information on time and date of photography is available. Alternatively, the image data sets in the latest order may be reproduced after the image data sets in the past order.

In the second embodiment, the image data sets in the latest order are added to the image data sets in the recording medium M. However, all image data sets recorded in a plurality of recording media M may be subjected to the classification and the selection for newly recorded in one of the recording media M or in a new recording medium M. In this case, if the image storage server 15 has all the image data sets from all the recording media M, the image data sets are used as they are for the new recording. Otherwise, the image data sets are read from the recording media M and stored again in the image storage server 15 for the classification and the selection thereof, as in the second embodiment.

In the first and second embodiments described above, the image data sets Si are subjected to the classification and the selection at the sate time. However, the image data sets may only be classified or selected to be recorded in the recording medium M. In the first and second embodiments, the image data sets Si are subjected to the classification followed by the selection. However, the image data sets Si may be subjected to the selection followed by the classification,

In the first and second embodiments described above, the image storage server 15 may store audio data sets so that the user can select some of the audio data sets to be included in the file used for display of the slide show, while using the terminal 3.

What is claimed is:

1. An image recording apparatus comprising:
image acquisition means for obtaining image data sets;
classification selection means for carrying out classification and/or selection on the image data sets; and
media recording means for recording the image data sets that have been subjected to the classification and/or the selection in a portable recording medium.

2. The image recording apparatus according to claim 1, wherein the classification selection means carries out the classification on the image data sets according to either date of photography thereof or similarity between images represented by the image data sets.

3. The image recording apparatus according to claim 1, wherein the classification selection means carries out the classification on the image data sets according to scene characteristic thereof by analyzing the scene characteristic including at least one of: colors of images represented by the image data sets, density distribution therein, and a shape of a subject therein.

4. The image recording apparatus according to claim 1, wherein the classification selection means carries out the selection on the image data sets for selecting images representing no blur and a person or persons whose eyes are not closed.

5. The image recording apparatus according to claim 1, wherein the classification selection means carries out the classification first in the case where the classification and the selection are carried out.

6. The recording apparatus according to claim 1, wherein the classification selection means carries out the selection first in the case where the classification and the selection are carried out.

7. The image recording apparatus according to claim 1 further comprising reception means for receiving an instruction to carry out further classification and/or further selection on the image data sets that have been subjected to the classification and/or the selection and for carrying out the further classification and/or the further selection, wherein
the media recording means records in the recording medium the image data sets that have been subjected to the further classification and/or the further selection by the reception means.

8. The image recording apparatus according to claim 1, wherein the media recording means records the image data sets that have been subjected to the classification and/or the selection in the recording medium in a format that enables display of a slide show.

9. The image recording apparatus according to claim 8, wherein the media recording means records the image data sets in either a video CD format or a DVD video format in the recording medium.

10. The image recording apparatus according to claim 1, wherein the media recording means records in the recording medium the image data sets having been subjected to the classification and/or the selection in a manner that enables printing thereof.

11. An image recording method comprising the steps of:
obtaining image data sets;
carrying out classification and/or selection on the image data sets; and
recording the image data sets that have been subjected to the classification and/or the selection in a portable recording medium.

12. A program causing a computer to execute an image recording method comprising the steps of:
obtaining image data sets;
carrying out classification and/or selection on the image data sets; and
recording the image data sets that have been subjected to the classification and/or the selection in a portable recording medium.
